(19) United States
(12) Patent Application Publication
(10) Pub. No.: US 2007/0015579 A1
(43) Pub. Date: Jan. 18, 2007

(54) Remote control device

(75) Inventors: Yasuo Masaki, Osaka (JP); Yasunari Miyake, Osaka (JP); Hideki Tanabe, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/487,167

(22) Filed: Jul. 14, 2006

(30) Foreign Application Priority Data
Jul. 14, 2005 (JP) 2005-205944 (P)

(51) Int. Cl. A63F 13/00

(52) U.S. Cl. 463/37; 446/37

(57) ABSTRACT

A remote control device is provided that functions as a device for controlling equipment of which image is picked up. The remote control device includes a camera, a drive circuit receiving an input of a signal output from the camera, an operation portion externally receiving an input of an instruction, a light-receiving portion receiving an input of an optical signal, a control circuit generating a signal for the remote control device to perform a predetermined process based on externally input data or command, a memory for reading and writing data, a display displaying an image based on the signal generated by the control circuit, and a signal output portion outputting the signal generated by the control circuit.

### BACKGROUND OF THE INVENTION

1. Field of the Invention

The present invention relates to a remote control device, and more particularly to a remote control device having an image pickup function.

2. Description of the Background Art

As for a remote control device capable of controlling a plurality of equipment, a user of the terminal conventionally needs to select equipment to be controlled (referred to as control target equipment hereinafter) to perform an operation such as the setting for controlling particular control target equipment, or data input.

The technique concerning a device for manipulating control target equipment is disclosed, for example, in Japanese Patent Laying-Open Nos. 2004-248128, 2001-258083, and 2000-349709.

### SUMMARY OF THE INVENTION

However, in order to realize a remote control device for a plurality of control target equipment, required operations vary from equipment to equipment and data input is necessary, as described above, which is not always convenient for the user. In addition, when erroneous inputs or settings are made as a result of such operations, the function as a remote control device for control target equipment may not be fulfilled.

The present invention is made to solve the aforementioned problems. An object of the present invention is to provide a remote control device capable of controlling a plurality of control target equipment.

Another object of the present invention is to provide a remote control device capable of functioning as a remote control device for particular control target equipment without an error.

Further object of the present invention is to provide a remote control device capable of easily adapting to addition of a function and other changes of functions of control target equipment.

Yet another object of the present invention is to provide a remote control device capable of easily realizing a setting as particular control target equipment.

In summary, in accordance with an aspect of the present invention, a remote control device is provided that controls control target equipment sending flashing light. The flashing light includes identification information for identifying the control target equipment. The identification information is specified by a flashing condition of the flashing light. The remote control device includes: an input portion externally receiving an input of an instruction; an image pickup portion picking up an image of a subject based on the instruction; and a reception portion receiving the flashing light sent by the control target equipment. The directivity of the reception portion is the same direction as an optical axis of the image pickup portion. The remote control device includes: a detection portion detecting the flashing condition of the flashing light received by the reception portion; an obtaining portion obtaining the identification information based on the flashing condition; an identification information storing portion storing the identification information obtained by the obtaining portion; a generation portion responsive to an input of an instruction through the input portion to generate a control signal for controlling an operation of the control target equipment based on the identification information stored in the identification information storing portion; and an output portion outputting the control signal.

Preferably, the remote control device further includes a casing. The image pickup portion and the reception portion are arranged on a predetermined face of the casing.

Preferably, the reception portion is arranged on the optical axis of the image pickup portion.

Preferably, the output portion includes a conversion portion converting the control signal to infrared light, and a light-emitting portion applying the infrared light.

Preferably, the output portion includes a conversion portion converting the control signal to control data according to a communication line connected to the control target equipment, and a transmission portion transmitting the control data to the control target equipment via the communication line.

Preferably, the remote control device further includes: an item obtaining portion obtaining a control item defining an operation by the control target equipment based on the identification information; and a storage portion storing the control item obtained by the item obtaining portion in relation with the identification information. The generation portion generates the control signal based on the control item stored in the storage portion and the identification information.

Preferably, the item obtaining portion includes a transmission request portion asking the control target equipment for transmission of the control item via a communication line connected to the control target equipment, and an item receiving portion receiving the control item transmitted by the control target equipment via the communication line.

Preferably, the item obtaining portion includes a feeding portion connected to a communication line to feed a transmission request for the control item to an information providing device providing the control item via the communication line, and an item receiving portion receiving the control item transmitted according to the transmission request via the communication line.

Preferably, the item obtaining portion includes a reception portion receiving a control signal sent by a remote control terminal unique to the control target equipment.

Preferably, the remote control device further includes: a storage portion storing a control item obtained beforehand for the control target equipment and identification information of the control target equipment; and a determination portion determining whether or not the identification information obtained by the obtaining portion agrees with the identification information stored in the storage portion. The generation portion generates the control signal based on the control item obtained beforehand, if the identification information obtained by the obtaining portion agrees with the identification information stored in the storage portion.

Preferably, the remote control device further includes: an image data storing portion storing data generated by picking up an image of the subject; a display portion displaying an image; and a display control portion displaying the image of the subject picked up by the image pickup portion on the display portion based on the data stored in the image data storing portion, until the obtaining portion obtains the identification information.

In accordance with another aspect of the present invention, a remote control device is provided that controls control target equipment sending flashing light. The flashing light includes identification information for identifying the control target equipment. The identification information is specified by a flashing condition of the flashing light. The remote control device includes: a casing; an input portion externally receiving an input of an instruction; an image pickup portion arranged on a predetermined face of the casing to pick up an image of a subject based on the instruction; an image data storing portion storing data generated by picking up an image of the subject; a display portion displaying an image; and a reception portion arranged on a predetermined face of the casing to receive the flashing light sent by the control target equipment. The directivity of the reception portion is the same direction as an optical axis of the image pickup portion. The remote control device includes: a detection portion detecting the flashing condition of the flashing light received by the reception portion; an obtaining portion obtaining the identification information based on the flashing condition; a display control portion displaying on the display portion an image of the subject picked up by the image pickup portion based on the data stored in the image data storing portion, until the obtaining portion obtains the identification information; an identification information storing portion storing the identification information obtained by the obtaining portion; a generation portion responsive to an input of an instruction through the input portion to generate a control signal for controlling an operation of the control target equipment based on the identification information; a conversion portion converting the control signal to infrared light; and a light-emitting portion applying the infrared light.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a room 10 in which equipment that can be controlled by a remote control device in accordance with the present invention is placed.

FIG. 2 shows an external view of remote control device 100.

FIG. 3 is a block diagram illustrating a hardware configuration of remote control device 100.

FIG. 4 illustrates a schematic configuration of a light-receiving portion 120 of the remote control device in accordance with the present invention.

FIG. 5 illustrates a display region appearing on a display 102 based on an optical signal received through light-receiving portion 120.

FIG. 6 illustrates a schematic configuration of a light-receiving portion of the remote control device in accordance with another aspect.

FIG. 7 is a block diagram illustrating a functional configuration of a control circuit 210 of remote control device 100.

FIG. 8 is a block diagram illustrating a hardware configuration of an HDD recorder 40.

FIG. 9 is a block diagram illustrating a functional configuration of a system control circuit 510 that realizes HDD recorder 40.

FIG. 10 is a block diagram illustrating an exemplary configuration of an optical signal 700 transmitted from control target equipment to remote control device 100.

FIG. 11 is a flowchart illustrating a procedure of a process performed by system control circuit 510 to transmit identification information of HDD recorder 40.

FIG. 12 is a flowchart illustrating a procedure of a process performed by control circuit 210 for remote control device 100 to authenticate control target equipment.

FIG. 13 schematically illustrates data stored in a memory 220 of remote control device 100 after HDD recorder 40 is authenticated.

FIG. 14 illustrates a screen displayed while remote control device 100 is authenticating control target equipment.

FIG. 15 is a flowchart illustrating a procedure of a process performed by remote control device 100 to control the control target equipment.

FIGS. 16A and 16B illustrate a manner of displaying an image on display 102.

FIG. 17 is a flowchart illustrating a procedure of a process performed by remote control device 100, which has already authenticated control target equipment, to authenticate an air conditioner 20.

FIG. 18 illustrates data stored in memory 220 when remote control device 100 authenticates air conditioner 20 as a control target.

FIG. 19 illustrates an image displayed when remote control device 100 recognizes air conditioner 20.

FIG. 20 illustrates a manner in which control target equipment controllable by remote control device 100 in accordance with a second embodiment of the present invention is connected via a network 1790.

FIG. 21 illustrates a manner in which equipment having a function of transmitting information for identifying the control target equipment itself via a network is connected to the network.

FIG. 22 illustrates a manner in which control items and control data are stored in a memory 1836 of a television 1830 in accordance with a third embodiment of the present invention.

FIG. 23 illustrates a manner in which control target equipment for remote control device 100 in accordance with a fourth embodiment of the present invention is connected to the Internet.

FIG. 24 is a flowchart illustrating a procedure of a process performed by control circuit 210 of the remote control device in accordance with the fourth embodiment of the present invention.

FIG. 25 is a flowchart illustrating a procedure of a process performed by an information providing server 2030 in accordance with the fourth embodiment of the present invention.

FIG. 26 illustrates a state of communication of a signal between remote control device 100 in accordance with a fifth embodiment of the present invention and a remote control device 2300 unique to control target equipment.

FIG. 27 is a flowchart illustrating a procedure of a process performed by remote control device 100 in accordance with the fifth embodiment of the present invention to perform a learning operation for another remote control device 2300.

FIG. 28 is a flowchart illustrating a procedure of a process performed by control circuit 210 to update control items of control target equipment.

### DESCRIPTION OF THE PREFERRED EMBODIMENTS

In the following, with reference to the figures, the embodiments of the present invention will be described. In the following description, the same parts will be denoted with the same reference characters. The designations and functions are also the same. Therefore, detailed description thereof will not be repeated.

### First Embodiment

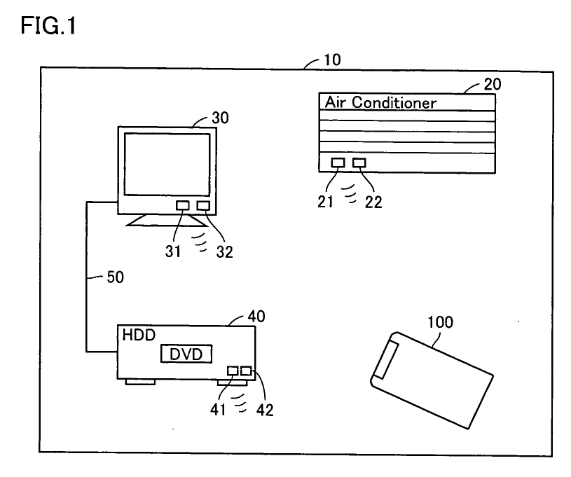

Referring to FIG. 1, a usage manner of a remote control device 100 in accordance with an embodiment of the present invention will be described. FIG. 1 illustrates a room 10 in which equipment that can be controlled by remote control device 100 is placed.

An air conditioner 20, a television 30, and an HDD recorder 40 are placed in room 10. Air conditioner 20 includes a light-emitting portion 21 emitting a signal including identification information of the air conditioner itself and a light-receiving portion 22 receiving a control signal emitted from remote control device 100. Television 30 includes a light-emitting portion 31 emitting a signal including identification information of the television itself and a light-receiving portion 32 receiving a control signal emitted from remote control device 100. Television 30 and HDD recorder 40 are connected to each other via a cable 50. HDD recorder 40 includes a light-emitting portion 41 emitting a signal including information that identifies the HDD recorder itself and a light-receiving portion 42 receiving a control signal emitted from remote control device 100.

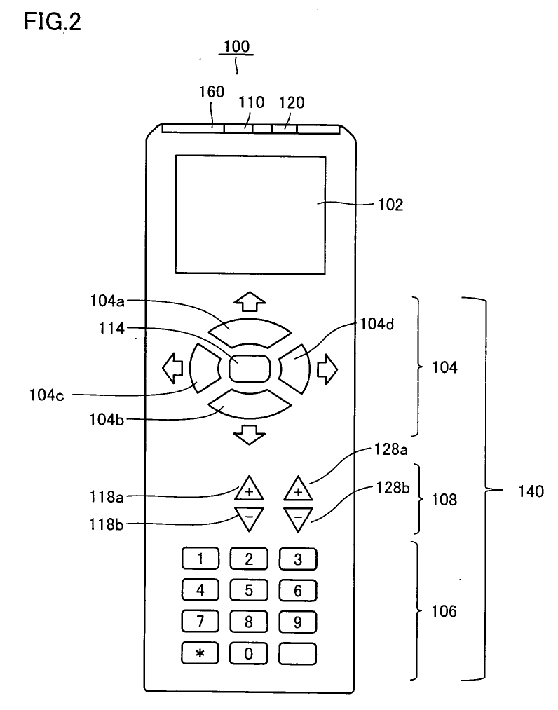

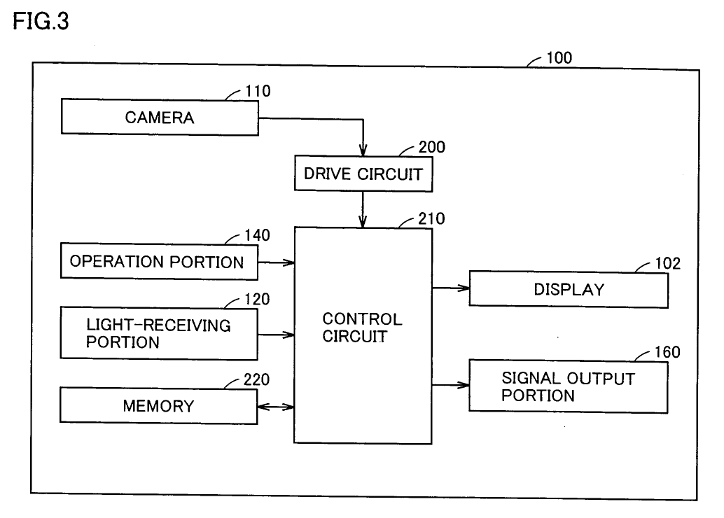

Referring to FIG. 2 and FIG. 3, remote control device 100 in accordance with the present embodiment will be described. FIG. 2 shows an external view of remote control device 100.

Remote control device 100 includes a camera 110 picking up an image of a subject to output a video signal, a light-receiving portion 120 receiving an optical signal, a light-emitting portion 160 emitting a control signal to control target equipment, a display 102, and an operation portion 140 externally receiving an input of an instruction to output a signal according to the input. Camera 110 and light-receiving portion 120 are arranged in proximity to each other on the same surface so as to receive an input of an optical signal in accordance with the same optical axis. It is noted that the arrangement of camera 110 and light-receiving portion 120 is not limited to the one shown in FIG. 2. For example, light-receiving portion 120 may be arranged to receive an optical signal on the optical axis of camera 110. In this case, a reflector (not shown) or any other branch portion for branching an optical signal may be arranged on the optical axis of camera 110 so that light-receiving portion 120 receives an input of an optical signal from the branch portion.

Camera 110 is realized, for example, by a light-receiving element having a photoelectric conversion function and an element having a signal transfer function such as CCD (Charge Coupled Device). Display 102 is realized by a liquid crystal display, an organic EL (Electro Luminescence) display or the like.

Operation portion 140 is realized, for example, by a button or a dial. Operation portion 140 includes cursor buttons 104a, 104b, 104c, 104d defining up/down and right/left directions of the cursor appearing on display 102, a decision button 114 receiving an input of an instruction to confirm data input by the user of remote control device 100, an up/down button 108 for upping or downing the value of the output control signal, and a numeric button 106. Up/down button 108 includes a first up button 118a, a first down button 118b, a second up button 128a, and a second down button 128b.

FIG. 3 is a block diagram illustrating a hardware configuration of remote control device 100. Remote control device 100 includes camera 110, a drive circuit 200 receiving an input of a signal output from camera 110, operation portion 140 externally receiving an input of an instruction, light-receiving portion 120 receiving an input of an optical signal, a control circuit 210 generating a signal for remote control device 100 to perform a predetermined process based on the externally input data or command, a memory 220 for reading and writing data, display 102 displaying an image based on a signal generated by control circuit 210, and a signal output portion 160 outputting a signal generated by control circuit 210.

The signal generated by drive circuit 200 is input to control circuit 210. Control circuit 210 performs predetermined image processing on the signal and generates data for displaying an image on display 102. Operation portion 140 outputs an electrical signal to control circuit 210 according to the input instruction. Control circuit 210 performs a predetermined process according to the signal. Light-receiving portion 120 receives an optical signal including a control signal that is predetermined between control target equipment and remote control device 100. Light-receiving portion 120 has a photoelectric conversion function and converts the signal to an electrical signal based on the function to output the converted signal to control circuit 210.

Memory 220 is a memory for storing data in a nonvolatile manner. Memory 220 is realized, for example, by a flash memory. Memory 220 receives an input of data for specifying a function of control target equipment from control circuit 210 for storage into a predetermined region.

When remote control device 100 functions as a remote control for the control target equipment, control circuit 210 generates a signal for performing a predetermined process based on the data stored in that region. Control circuit 210 feeds the generated signal to signal output portion 160. Control circuit 210 may be realized by a circuit element preliminary configured to perform each process or may be realized by causing CPU (Central Processing Unit) or any other processing unit to execute a program for realizing each process.

Signal output portion 160 feeds the control signal output from control circuit 210 to the outside. In one aspect, signal output portion 160 sends an infrared signal. In another aspect, signal output portion 160 is connected, for example, to a communication line to perform a process for transmitting the control signal as a packet.

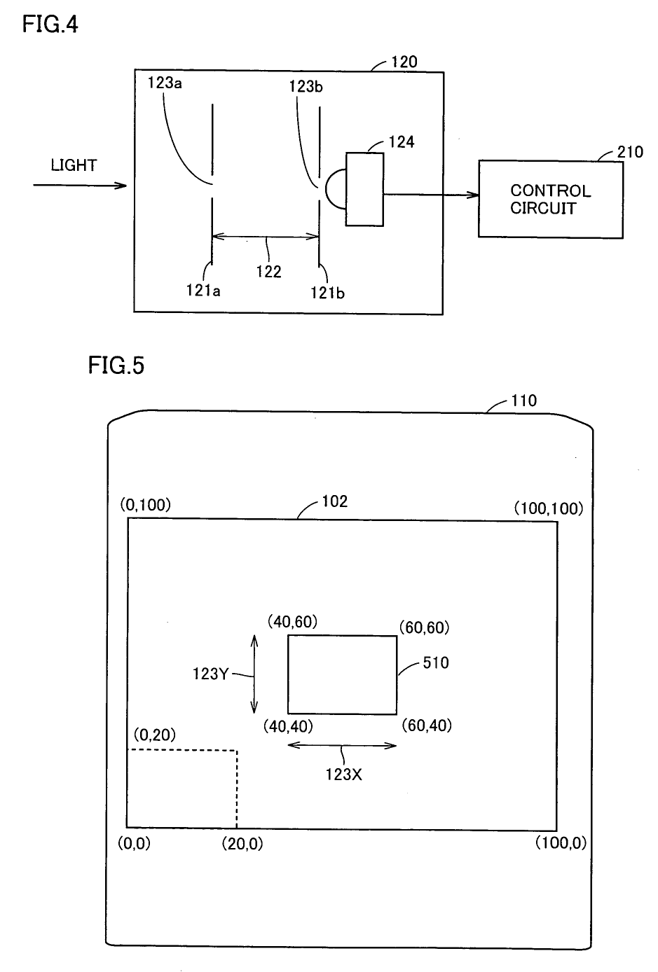

Referring to FIG. 4, light-receiving portion 120 of the remote control device in accordance with the present invention will be described. FIG. 4 illustrates the schematic configuration of light-receiving portion 120.

Light-receiving portion 120 includes slits 121a, 121b, and an optical sensor 124. Slit 121a and slit 121b are arranged to be separated from each other by a slit spacing 122. A gap 123a is formed in slit 121a. Similarly, a gap 123b is formed in slit 121b.

Referring to FIG. 5, display of an image in remote control 100 will be described. FIG. 5 illustrates a region in which an image is displayed based on an optical signal received through light-receiving portion 120.

The light incident on light-receiving portion 120 is sensed by optical sensor 124 through slit 121a and slit 121b. The optical signal sensed by optical sensor 124 is converted to an electrical signal by a well-known photoelectric conversion function for display on display 102. In the example shown in FIG. 3, control circuit 210 performs a process for the display. As a result of the process, as shown in FIG. 5, in the display region of display 102, an image based on the optical signal passed through the gaps of slits 121a, 121b is displayed in a partially predetermined region 510. When each of the above-noted gap is rectangular, region 510 is displayed as a rectangle. For example, the rectangle has a length of 123Y in the longitudinal direction and a length of 123X in the lateral direction. Each length is naturally defined according to the length of the gap.

It is noted that the gap of the slit may have a preliminary fixed value or may vary according to an instruction to change.

Furthermore, region 510 appears at the middle of display 102 in the example shown in FIG. 5. However, it may be displayed in the peripheral part. Region 510 can be positioned in display 102 by control circuit 210 switching the output destination of the signal from optical sensor 124. For example, the values of the coordinates for specifying the location of region 510 in display 102 are changed, so that region 510 is displayed at a position corresponding to the changed values.

For example, when region 510 is specified by coordinate values (40, 40)-(60, 60), as shown in FIG. 5, region 510 is displayed approximately at the middle of display 102. Here, if the coordinate values are changed, for example, to (0,0)-(20, 20), the end point of the lower-left part of region 510 after change is moved to the position of end point 520 in display 102. As a result, region 510 appears at the lower-left part of display 102.

The display location of region 510 may be changed by an input through operation portion 140. In this case, for example, control circuit 210 calculates the amount of movement according to the operation on cursor buttons 104a-104d and then computes again the coordinate values for specifying the display position of region 510 based on the amount of movement. Control circuit 210 outputs data to display region 510 based on the coordinate values computed again, so that the location of region 510 is switched. In this way, the optical axis can be aligned to the control target equipment to be recognized by remote control device 100, ensuring that the remote control device can capture the optical signal from the control target equipment.

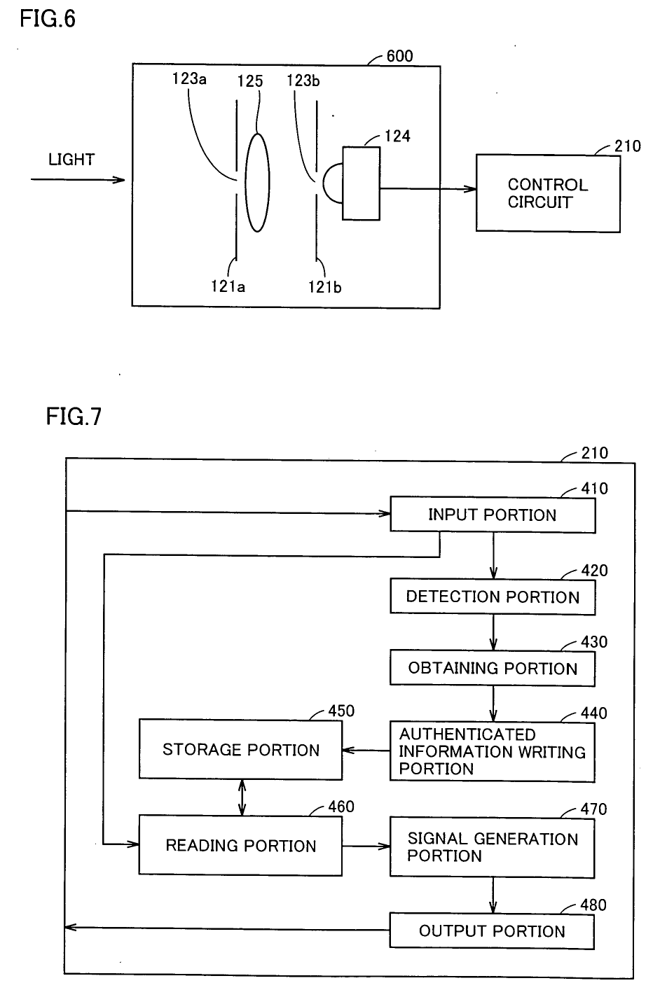

Referring to FIG. 6, a light-receiving portion of the remote control device in accordance with another aspect will be described. FIG. 6 illustrates the schematic configuration of a light-receiving portion 600 having a lens.

Light-receiving portion 600 includes a lens 125 in addition to the configuration shown in FIG. 4. Lens 125 is arranged in the rear direction from slit 121a with respect to the incident light. The incoming light through gap 123a is condensed by lens 125 and propagates to slit 121b. The condensed light propagates to optical sensor 124 through gap 123b. Optical sensor 124 senses the optical signal and performs photoelectric conversion based on the sensed optical signal to transmit an electrical signal to control circuit 210.

In this way, the remote control device can obtain an optical signal having an intensity higher than without lens 125. Accordingly, the precision of capturing an external optical signal is improved, thereby ensuring the recognition of control target equipment.

Now, referring to FIG. 7, the functional configuration of control circuit 210 of remote control device 100 will be described. FIG. 7 is a functional block diagram of control circuit 210.

Control circuit 210 includes an input portion 410 externally receiving an input of a signal, a detection portion 420 detecting information stored in the signal based on the signal received from input portion 410, an obtaining portion 430 obtaining particular information from the detected signal, authenticated information writing portion 440 performing a process for storing authenticated information based on the obtained information, a storage portion 450 storing data, a reading portion 460 reading data stored in storage portion 450 based on the input through input portion 410, a signal generation portion 470 generating a signal for controlling control target equipment based on the data read by reading portion 460, and an output portion 480 outputting the signal generated by signal generation portion 470.

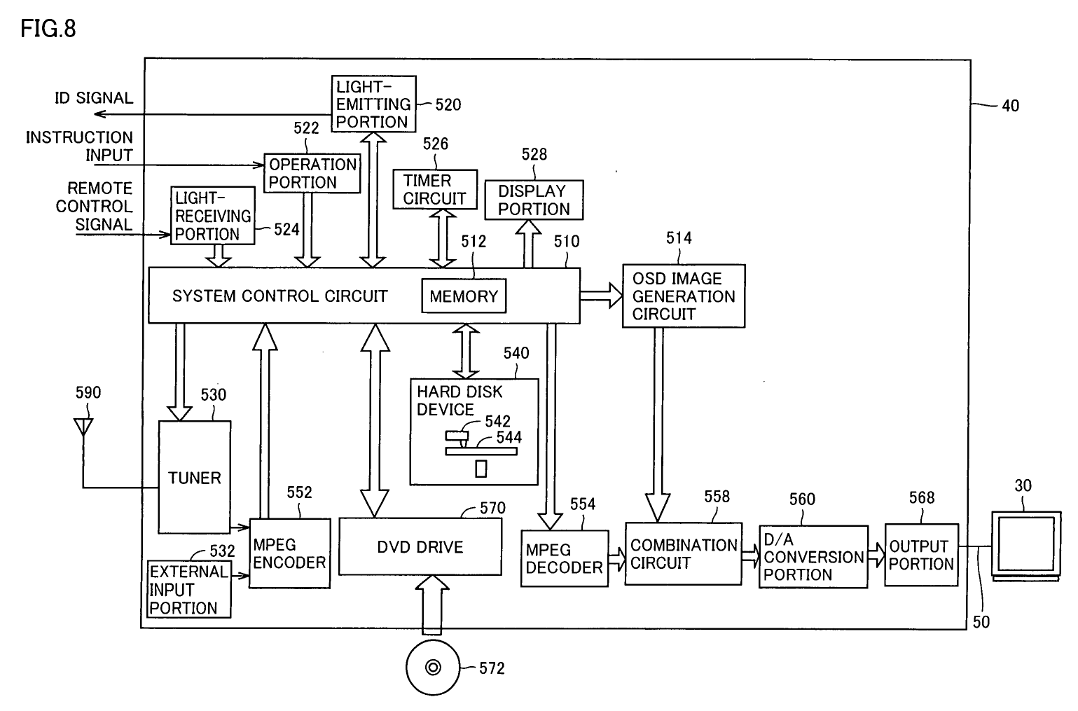

Referring to FIG. 8, HDD recorder 40 in accordance with the present embodiment will be described. FIG. 8 is a block diagram illustrating the hardware configuration of HDD recorder 40. HDD recorder 40 is connected to television 30 via cable 50.

HDD recorder 40 includes a light-receiving portion 524 externally receiving a remote control signal, an operation portion 522 receiving an input of an instruction, and a light-emitting portion 520 emitting infrared light including information for identifying HDD recorder 40 to the outside. HDD recorder 40 further includes an antenna 590, a tuner 530 obtaining a signal of a selected channel based on a video signal received by antenna 590, an external input portion 532 externally receiving an input of a video/audio signal, a system control circuit 510 performing a process for controlling the operation of HDD recorder 40, and an MPEG (Moving Picture Experts Group) encoder 552 receiving an input of a video signal from tuner 530 and external input 532 to generate digital data by performing a predetermined compression coding process.

HDD recorder 40 further includes a DVD drive 570, a hard disk device 540, an MPEG decoder 554 for decoding digital data, an OSD (On Screen Display) image generation circuit 514 for generating an image appearing on a display region of an image display device connected to HDD recorder 40, a combination circuit 558 combining the signals from MPEG decoder 554 and OSD image generation circuit 514 for output, a D/A (Digital to Analog) conversion portion 560 for converting a digital signal to an analog signal, and an output portion 568 for outputting an analog video/audio signal to the outside.

DVD 572 is inserted into DVD drive 570. Hard disk device 540 includes a hard disk 544 recording digital information and a pickup 542 for storing data in hard disk 544 and reading data from hard disk 544.

It is noted that the operation performed by DVD drive 570 and hard disk device 540 can easily be understood by those skilled in the art and therefore the detailed description will not be repeated here.

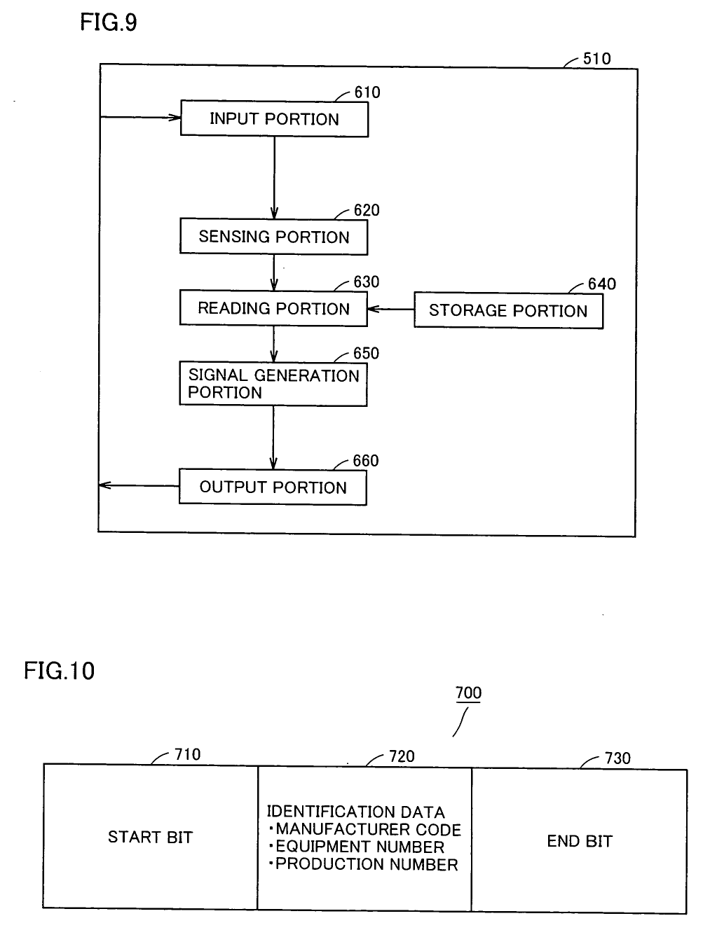

Referring to FIG. 9, system control circuit 510 realizing HDD recorder 40 will be described. FIG. 9 is a block diagram illustrating the functional configuration of system control circuit 510.

System control circuit 510 includes an input portion 610 externally receiving an input of a signal, a sensing portion 620 sensing a transmission request for information for identifying HDD recorder 40 based on the signal, a reading portion 630 responsive to the sensing for reading the information from a storage portion 640 storing identification information, a signal generation portion 650 for generating a transmission signal based on the identification information read by reading portion 630, and an output portion 660 outputting a signal generated by signal generation portion 650. Output portion 660 outputs a signal for transmission to light-emitting portion 520. Light-emitting portion 520 emits the signal toward a predetermined direction as an infrared signal.

Now, referring to FIG. 10, a signal sent by HDD recorder 40, television 30, air conditioner 20, and other control target equipment will be described. FIG. 10 is a block diagram illustrating an exemplary configuration of an optical signal 700 transmitted from control target equipment to remote control device 100.

Optical signal 700 includes a start bit 710, identification data 720, and an end bit 730. Start bit 710 includes data for specifying the head portion of an optical signal transmitted one by one. Identification data 720 includes information for identifying control target equipment including, for example, a manufacturer code, equipment number, production number of the equipment. End bit 730 includes data for specifying the end portion of an optical signal transmitted one by one.

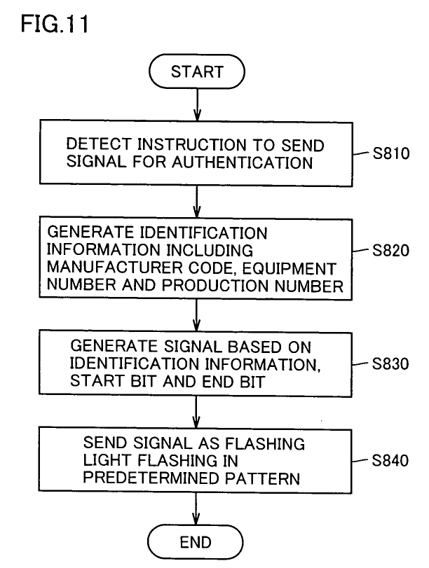

Referring to FIG. 11, the control structure of HDD recorder 40 will be described. FIG. 11 is a flowchart illustrating a procedure of a process performed by system control circuit 510 to transmit identification information of HDD recorder 40.

At step S810, system control circuit 510 of HDD recorder 40 detects an instruction to send a signal for authenticating equipment from the signal received by light-receiving portion 524. At step S820, system control circuit 510 generates identification information including the manufacturer code, equipment number and production number of HDD recorder 40 based on the data stored in memory 512. At step S830, system control circuit 510 generates a signal (FIG. 10) for transmission based on the identification information, a start bit, and an end bit.

At step S840, system control circuit 510 causes light-emitting portion 520 to send the signal as flashing light that flashes in a predetermined pattern. As a result, an infrared signal including the information identifying HDD recorder 40 is sent one by one from light-emitting portion 520 toward a predetermined direction.

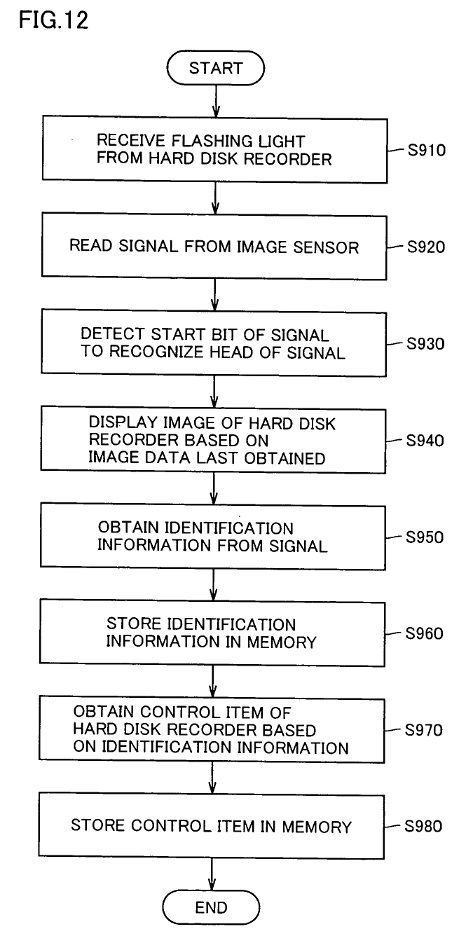

Referring to FIG. 12, the control structure of remote control device 100 in accordance with the present embodiment will be described. FIG. 12 is a flowchart illustrating a procedure of a process performed by control circuit 210 to authenticate control target equipment.

At step S910, control circuit 210 receives the flashing light sent by HDD recorder 40. At step S920, control circuit 210 reads the signal obtained by light-receiving portion 120. At step S930, control circuit 210 recognizes the head of the signal by detecting the start bit of the signal. At step S940, control circuit 210 causes an image of HDD recorder 40 to appear on display 102 based on the image data last obtained by camera 110.

At step S950, control circuit 210 obtains the identification information of HDD recorder 40 from the obtained information. At step S960, control circuit 210 stores the obtained identification information in a predetermined region in memory 220.

At step S970, control circuit 210 obtains a control item of HDD recorder 40 based on the identification information. Here, the control item refers to a process item, that may be controlled by remote control device 100, of the functions that can be performed by HDD recorder 40. At step S980, control circuit 210 stores the obtained control item in a predetermined data region in memory 220.

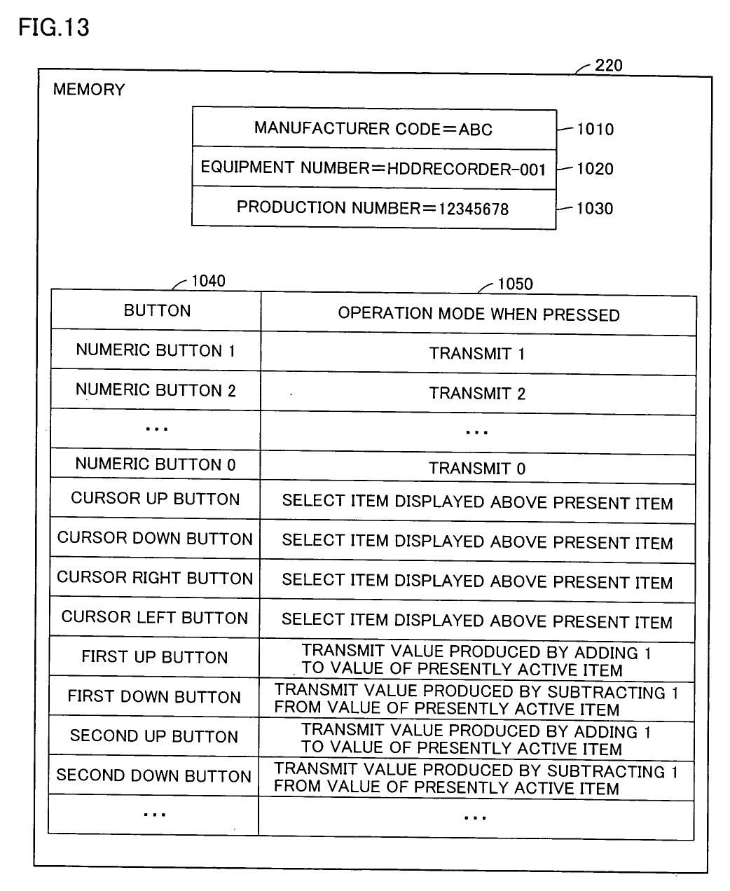

Now, referring to FIG. 13, data structure in remote control device 100 will be described. FIG. 13 schematically illustrates data stored in memory 220 of remote control device 100 after HDD recorder 40 is authenticated.

Memory 220 includes a region 1010 to a region 1050 for storing data. The manufacturer code “ABC” of HDD recorder 40 is stored in region 1010. The equipment number “HDDRECORDER-001” of HDD recorder 40 is stored in region 1020. The production number “12345678” of HDD recorder 40 is stored in region 1030.

The information identifying each button provided as operation portion 140 of remote control device 100 is stored in region 1040. The operation mode at the time of pressing a button, which is related to each button, is stored in region 1050. For example, a numeric button “1” is set to transmit data of “1” when the button is pressed. Furthermore, the cursor up button is set to perform a process for selecting an item displayed above the item presently displayed on display 102, when the button is pressed. Furthermore, for example, “the first up button” is set to be able to transmit the value produced by adding “1” to the value of the presently active item (in other words, the controllable item), when the button is pressed. For example, if the first up button functions as a button for selecting a channel, the channel number is upped by one when the first up button is pressed.

In this manner, the data stored in region 1040 is related with the data stored in region 1050, so that remote control device 100 can send a signal for performing an operation according to control target equipment in response to pressing each button.

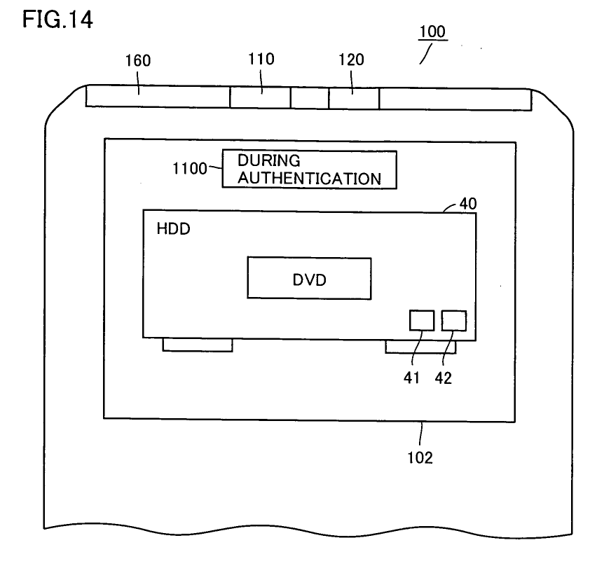

Here, referring to FIG. 14, a manner of displaying an image on display 102 of remote control device 100 will be described. FIG. 14 illustrates a screen displayed while remote control device 100 is authenticating control target equipment.

If remote control device 100 receives a signal, for example, from HDD recorder 40 to perform a process of authenticating HDD recorder 40, display 102 displays an image based on the data stored in memory 220. More specifically, without receiving an input of a signal based on an image picked by camera 110, control circuit 210 reads the image data stored in a predetermined buffer region in memory 220 and outputs the data to display 102. In this way, even when remote control device 100 requires time to authenticate control target equipment, display 102 continues to temporally display a still image. Therefore, even if the user of remote control device 100 moves the terminal, the image appearing on display 102 is not changed, so that the user no longer feels uncomfortable.

In addition, because of such display, it can be confirmed that remote control device 100 processes a signal, so that the user no longer needs to direct remote control device 100 to control target equipment (for example, HDD recorder 40) and can place remote control device 100 on a table or the like. In the example shown in FIG. 14, while remote control device 100 performs the authentication process, a message 1100 indicating “during authentication” appears on display 102. Therefore, the user sees the message to easily recognize that remote control device 100 is now performing the authentication process for equipment.

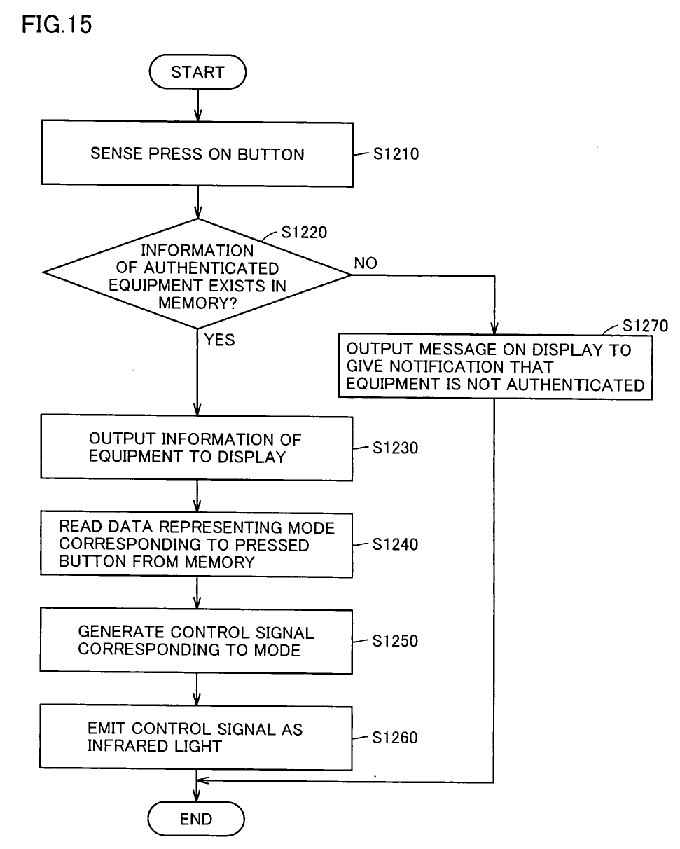

Now, referring to FIG. 15, the control structure of remote control device 100 will be described again. FIG. 15 is a flowchart illustrating a procedure of a process performed by remote control device 100 to control the control target equipment. This process is performed when the user uses remote control device 100 as a remote control device dedicated to particular control target equipment (for example, HDD recorder 40, television 30, air conditioner 20).

At step S1210, control circuit 210 senses a press on a button based on an input through operation portion 140. At step S1220, control circuit 210 determines whether or not information of the authenticated equipment exists in the memory based on a signal from the operation portion 140. If the information exists in the memory (YES at step S1220), the process moves on to step S1230. If not (NO at step S1220), the process moves on to step S1270.

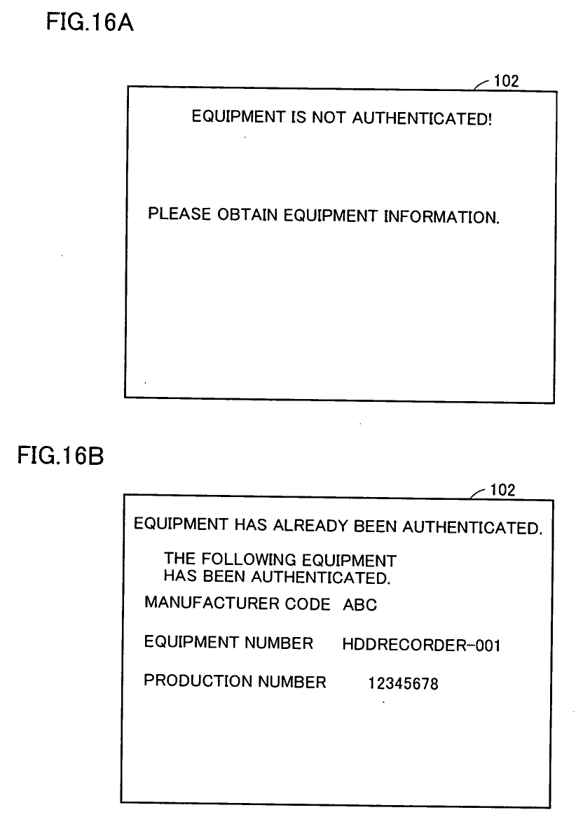

At step S1230, control circuit 210 outputs the information of the authenticated equipment to display 102. Display 102 displays the information of the equipment. This display manner will be described with reference to FIGS. 16A and 16B.

At step S1240, control circuit 210 reads data representing the mode corresponding to the pressed button which is stored in memory 220. At step S1250, control circuit 210 generates a control signal corresponding to the mode. At step S1260, control circuit 210 outputs the control signal as infrared light through signal output portion 160.

At step S1270, control circuit 210 outputs a message to display 102 to give notification that the equipment is not authenticated. Display 102 displays the message in the display region.

Referring to FIGS. 16A and 16B, a manner of displaying an image in display 102 will be described. FIG. 16A represents an image displayed when control target equipment is not authenticated by remote control device 100. More specifically, display 102 displays a message that authentication of control target equipment has not been completed and a message that prompts for obtaining information of the equipment. This display is realized, for example, by storing the data in memory 220 in advance and reading the data when the process at the above-noted step S1270 is performed. Such display allows the user of remote control device 100 to promptly recognize that the authentication process has not been completed. Therefore, the user directs remote control device 100 to control target equipment to obtain a signal again, ensuring that the authentication process is realized.

FIG. 16B represents an image displayed when control target equipment has been authenticated. In this case, remote control device 100 displays information of the equipment on display 102 based on the data stored in memory 220. In the example shown in FIG. 16B, it is displayed that the equipment with the manufacturer code “ABC”, the equipment number “HDDRECORDER-001”, the production number “12345678” is authenticated as the authenticated equipment.

Here, remote control device 100 functions as a remote control device for another control target equipment by way of illustration. In the following, remote control device 100 which initially functions as a remote control device for HDD recorder 40 will function as a remote control device for air conditioner 20 after the process of authenticating control target equipment again.

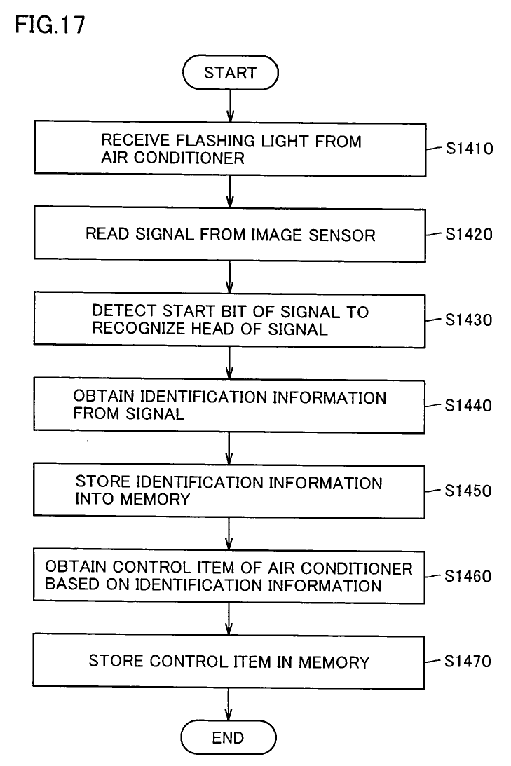

Referring to FIG. 17, the control structure of remote control device 100 will be further described. FIG. 17 is a flowchart illustrating a procedure of a process performed by remote control device 100, which has already authenticated control target equipment, to authenticate air conditioner 20. This process is realized, for example, when the user of remote control device 100 directs remote control device 100 to light-emitting portion 21 of air conditioner 20 to perform a predetermined operation.

At step S1410, control circuit 210 receives flashing light sent by air conditioner 20 through light-receiving portion 120. At step S1420, control circuit 210 reads the signal obtained by light-receiving portion 120 through drive circuit 200.

At step S1430, control circuit 210 recognizes the head of the signal by detecting the start bit of the signal. At step S1440, control circuit 210 obtains identification information included in the signal. At step S1450, control circuit 210 stores the authentication information (that is, air conditioner 20) in a data region of memory 220.

At step S1460, control circuit 210 obtains a control item of the air conditioner based on the identification information of air conditioner 20. When control target equipment is air conditioner 20, its control item includes, for example, air volume control, temperature control, selection of operations (fan, cooler, dehumidifier, heater), a change of setting temperature, and a change of timer setting time. At step S1470, control circuit 210 stores the obtained control item in memory 220.

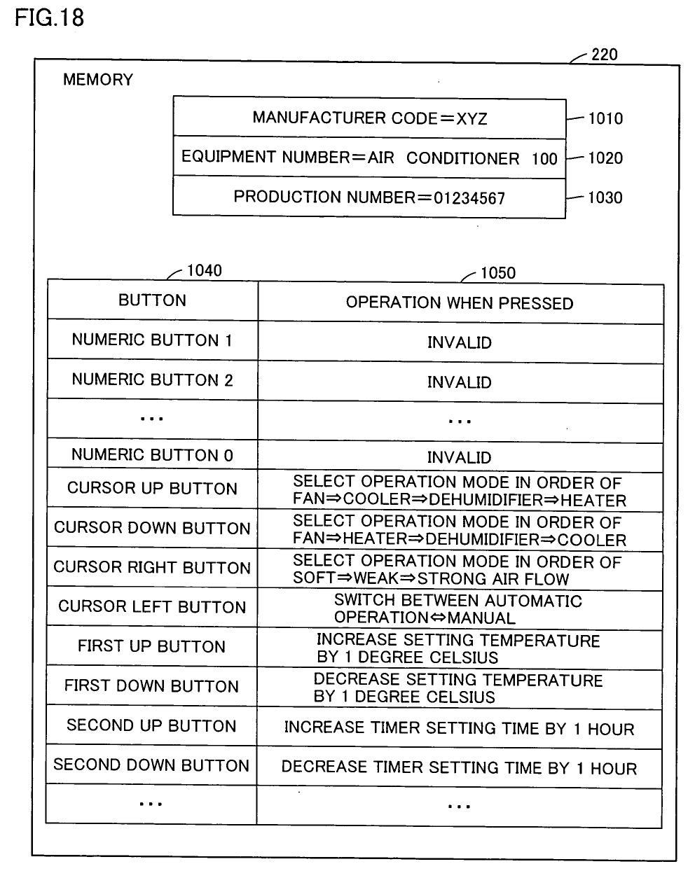

Referring to FIG. 18, the data structure of remote control device 100 will be described. FIG. 18 illustrates the data stored in memory 220 when remote control device 100 authenticates air conditioner 20 as a control target.

The manufacturer code (XYZ) of air conditioner 20 is stored in a region 1010. The equipment number (AIR CONDITIONER 100) of air conditioner 20 is stored in a region 1020. The production number (012345678) is stored in a region 1030.

Furthermore, in memory 220, the buttons provided as operation portion 140 of remote control device 100 are related with the respective operations of the buttons when pressed. For example, the “cursor up button” (cursor button 104a in FIG. 2) is set to switch the operations in the order of fan, cooler, humidifier, and heater when it is pressed.

Further, the first up button (up button 118a in FIG. 2) is set to output a control signal to up the setting temperature of air conditioner 20 by 1 degree Celsius when it is pressed. Similarly, the second up button (up button 128a in the same figure) is set to output a control signal to increase the timer setting time of air conditioner 20 by one hour.

On the other hand, numeric buttons “1” to “0” are set not to output any control signal even when they are pressed. In this case, the signal output in response to pressing the button represents “invalid”. In this manner, pressing a button is not related to any particular operation, so that even when the button is erroneously pressed, no control signal is output, thereby preventing an error.

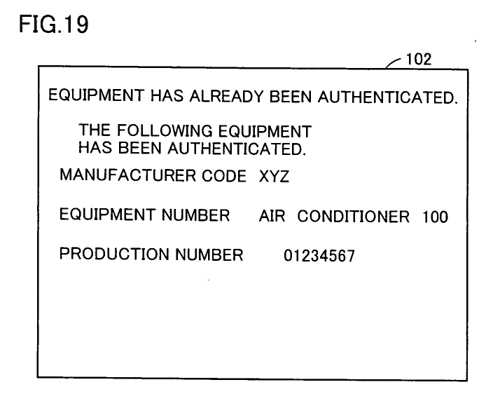

Referring to FIG. 19, a manner of displaying an image on display 102 of remote control device 100 in accordance with the present embodiment will be described again. FIG. 19 illustrates an image displayed when remote control device 100 recognizes air conditioner 20.

When the user directs remote control device 100 to air conditioner 20 to perform an operation for receiving a signal, remote control device 100 performs the authentication process described above to recognize air conditioner 20. Remote control device 100 obtains identification information included in the signal received from air conditioner 20 to write the information in memory 220. In this case, if any other control target equipment has already been authenticated, data for that equipment is overwritten with data for the newly recognized equipment.

Upon completion of authentication process, remote control device 100 displays a message on display 102 to give notification that the equipment is newly authenticated (FIG. 19). In other words, display 102 displays information for air conditioner 20 as the authenticated equipment. In this way, information of specific equipment is displayed according to the state of recognition by remote control device 100, so that the user of remote control device 100 can perform an operation on the terminal without an error.

As described above, remote control device 100 in accordance with the present embodiment receives a signal sent by control target equipment and obtains information included in the signal to authenticate the control target equipment. After the authentication, remote control device 100 functions as a remote control device corresponding to the control target equipment. In this manner, one terminal device can be used as a remote control device for each of a plurality of control target equipment.

### Second Embodiment

In the following, a second embodiment of the present invention will be described. Remote control device 100 in accordance with the present embodiment differs from the terminal in accordance with the embodiment described above in that it has a function of transmitting a control signal as a packet signal. More specifically, remote control device 100 converts a signal for controlling control target equipment into packet data. Remote control device 100 sends the packet data as a radio signal. Upon reception of the signal, a device that can receive the radio signal obtains the packet data generated by terminal 100 for transfer to particular control target equipment.

It is noted that the hardware configuration of the remote control device in accordance with the present embodiment is the same with the terminal in accordance with the embodiment described above. The functions are also the same. Therefore, description thereof will not be repeated here.

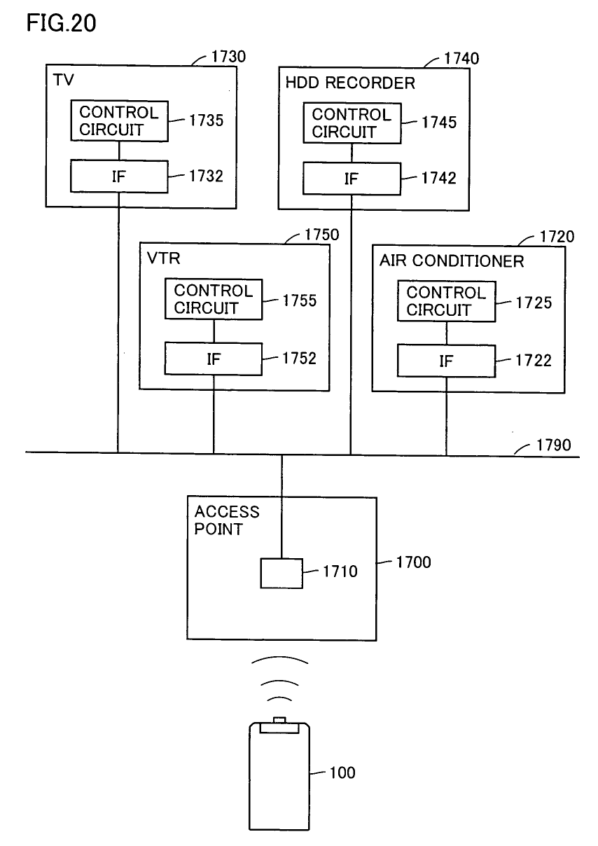

Referring to FIG. 20, a usage manner of remote control device 100 in accordance with the present embodiment will be described. FIG. 20 illustrates a manner in which control target equipment controllable by remote control device 100 is connected via a network 1790.

Network 1790 is connected with an access point 1700 receiving a radio signal. Access point 1700 includes a communication interface 1710 receiving a signal sent by remote control device 100 to transfer packet data to particular control target equipment via network 1790. Communication interface 1710 specifies a network address included in packet data and transmits a control signal directed to the address.

Network 1790 is further connected with a television 1730, an air conditioner 1720, an HDD recorder 1740, and a VTR 1750. Air conditioner 1720 includes an interface 1722 connected to network 1790 to receive an input of data from network 1790 and a control circuit 1725 for controlling an operation of air conditioner 1720 based on the control signal input through interface 1722.

Television 1730 includes an interface 1732 connected to network 1790 to receive an input of a control signal from network 1790 and a control circuit 1735 connected to interface 1732 to perform a process for controlling an operation of television 1730 based on a control signal.

HDD recorder 1740 includes an interface 1742 connected to network 1790 to receive an input of a signal from network 1790 and a control circuit 1745 performing a process for controlling an operation of HDD recorder 1740 based on the signal.

VTR 1750 includes an interface 1752 connected to network 1790 to receive an input of a signal from network 1790 and a control circuit 1755 performing a process for controlling an operation of VTR 1750 based on the signal.

In the control target equipment, interfaces 1722, 1732, 1742, 1752 each corresponds to a light-receiving portion receiving a remote control signal in the case where the control target equipment is used alone. Furthermore, the control circuit included in each control target equipment corresponds, for example, to system control circuit 510 for realizing HDD recorder 40 as shown in FIG. 8.

Each control circuit performs a particular process based on a signal from the interface electrically connected thereto, so that a similar process can be performed even when control target equipment is connected to network 1790.

As described above, in remote control device 100 in accordance with the second embodiment of the present invention, each control target equipment connected to network 1790 can be controlled. In other words, when the operation of each control target equipment is controlled, remote control device 100 may send a control signal to access point 1700. Therefore, the user needs not change the direction of remote control device 100 according to each control target equipment. Accordingly, the user can control each control target equipment without changing his/her posture. As a result, for example, when there exists an obstruction between the remote control device and any particular control target equipment, a control signal from remote control device 100 can be fed to the control target equipment, resulting in reliable control.

### Third Embodiment

In the following, a third embodiment of the present invention will be described. Remote control device 100 in accordance with the present embodiment differs from each embodiment described above in that it obtains information for authenticating control target equipment from an access point.

It is noted that the hardware configuration of the remote control device in accordance with the present embodiment is the same as the hardware configuration of the remote control device in accordance with each embodiment as described above. The functions are also the same. Therefore, description thereof will not be repeated here.

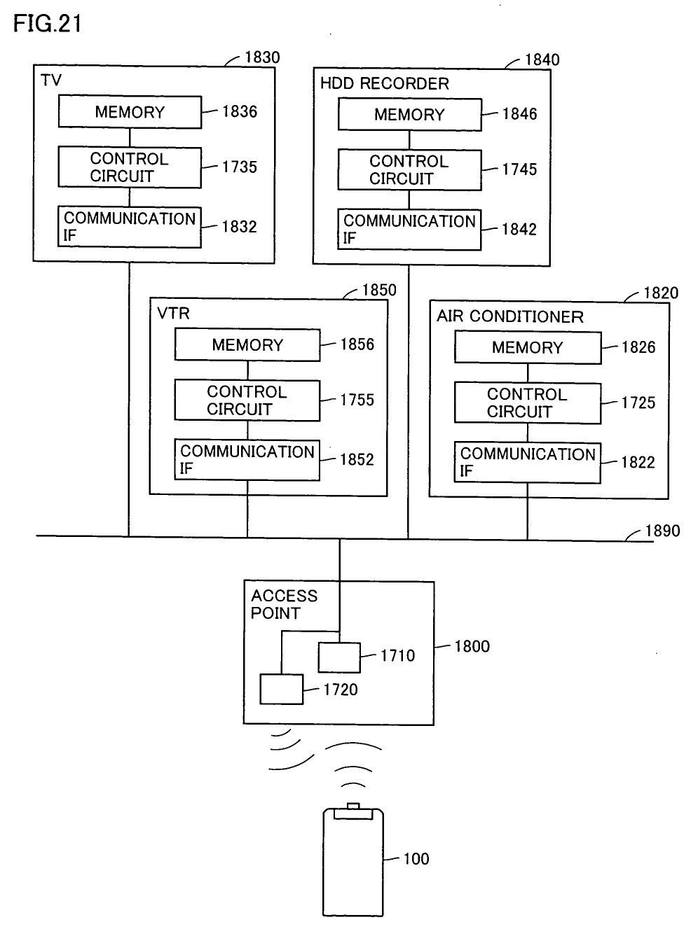

Referring to FIG. 21, a usage manner of the remote control device in accordance with the present embodiment will be described. FIG. 21 illustrates a manner in which equipment having a function of transmitting information for identifying the control target equipment itself via a network is connected to the network.

A network 1890 is connected with an air conditioner 1820, a television 1830, an HDD recorder 1840, a VTR 1850, and an access point 1800. Access point 1800 includes a reception portion 1710 receiving a signal from remote control device 100 and a sending portion 1720 sending a signal including information identifying each control target equipment based on a signal received via network 1890.

Air conditioner 1820 includes a control circuit 1725, a communication interface 1822 connected to network 1890 for communication with access point 1800 via network 1890, and a memory 1826 in which information for identifying air conditioner 1820 is stored.

Television 1830 includes a control circuit 1735, a communication interface 1832 connected to network 1890 for communication with access point 1800 via network 1890, and a memory 1836 in which information for identifying television 1830 is stored.

HDD recorder 1840 includes a control circuit 1745, a communication interface 1842 connected to network 1890 for communicating information with access point 1800 via network 1890, and a memory 1846 in which information for identifying HDD recorder 1840 is stored.

VTR 1850 includes a control circuit 1755, a communication interface 1852 connected to network 1890 for communicating information with access point 1800 via network 1890, and a memory 1856 in which information for identifying VTR 1850 is stored.

In such control target equipment, the information stored in each of memories 1826, 1836, 1846, 1856 is, for example, as shown in FIG. 10, a manufacturer code, an equipment number, a production number, and the like. An address (not shown) in network 1890 for each control target equipment is also stored in each memory.

Each of control circuits 1725, 1735, 1745, 1755 generates packet data to be transmitted to access point 1800 based on the information for identifying control target equipment and the network address which are stored in each memory. Each control circuit transmits the data to access point 1800 via the communication interface included in each equipment.

Based on the data input via network 1890, access point 1800 allows sending portion 1720 to send a signal including that data. The signal sent from access point 1800 differs depending on which of control target equipment connected to network 1890 transmits the packet data described above.

Therefore, for example, when air conditioner 1820 outputs packet data, access point 1800 sends a signal including the information for identifying air conditioner 1820. In another aspect, when HDD recorder 1840 transmits the packet data, access point 1800 sends a signal including the information for identifying HDD recorder 1840. In this way, remote control device 100 can communicate with each control target equipment through access point 1800, thereby facilitating authentication of control target equipment and transmission of a control signal after authentication.

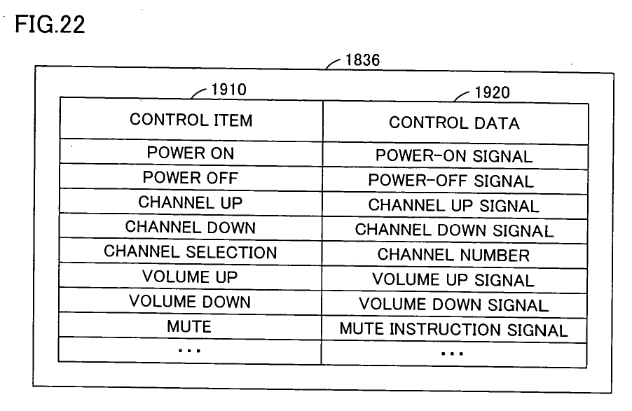

Here, referring to FIG. 22, the data structure of television 1830 in accordance with the present embodiment will be described. FIG. 22 illustrates a manner in which control items and control data are stored in memory 1836.

Memory 1836 includes a region 1910 in which data identifying a control item is stored and a region 1920 in which predetermined control data corresponding to the control item is stored. A control item and control data are related with each other. For example, a signal for giving an instruction for power-on is related as control data with a control item “power on”. Furthermore, a channel number is related as control data with a control item “channel selection”. The data in which control items are related with control data is stored in the memory of control target equipment, so that each equipment performs an operation according to a control signal of remote control device 100 that is received through access point 1800. In other words, when a signal from remote control device 100 corresponds to any of the control items, the control circuit outputs a signal corresponding to the item to control the operation of the control target equipment.

As described above, in accordance with the third embodiment of the present invention, remote control device 100 reliably obtains information of each control target equipment by communications through the access point. As a result, remote control device 100 can accurately authenticate each equipment. In addition, remote control device 100 can accurately obtain information for defining an operation in each equipment. Therefore, remote control device 100 can function as a remote control device for controlling a plurality of control target equipment.

### Fourth Embodiment

In the following, a fourth embodiment of the present invention will be described. The control items described above may be stored in control target equipment beforehand or may be externally obtained one by one. For example, data unique to each control target equipment may be stored as a control item in a server that provides the web site of the manufacturer producing each control target equipment, and then the data may be transmitted to a device that has requested a control item of control target equipment in response to access to the server.

It is noted that the hardware configuration of the remote control device in accordance with the present embodiment is the same as the hardware configuration of the remote control device in accordance with each embodiment described above. The functions are also the same. Therefore, description thereof will not be repeated.

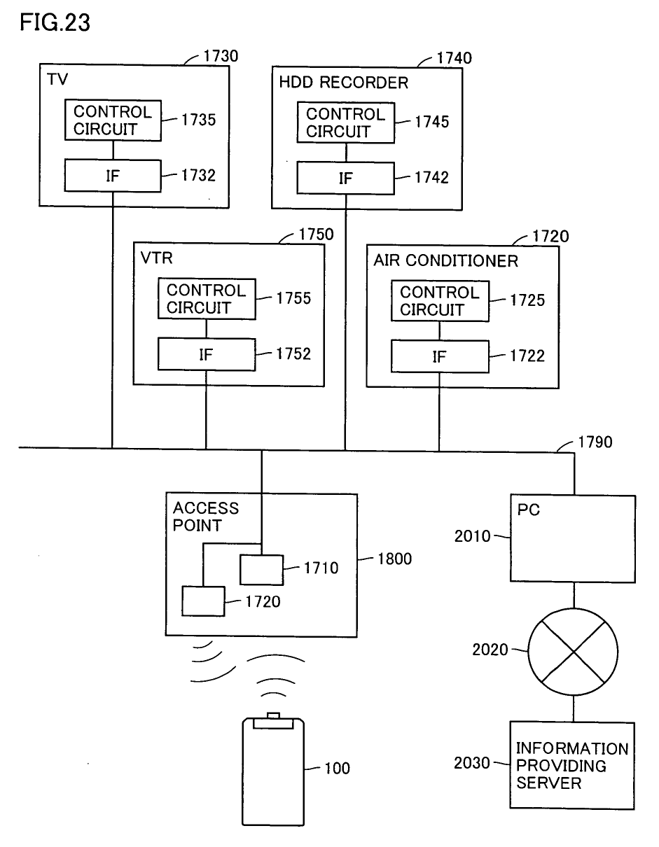

Referring to FIG. 23, a usage manner of remote control device 100 in accordance with the present embodiment will be described. FIG. 23 illustrates a manner in which control target equipment for remote control device 100 is connected to the Internet.

Network 1790 is connected to a PC (Personal Computer) 2010. PC 2010 is connected to an information providing server 2030 via the Internet 2020. Here, PC 2010 is a general computer system installed at home of the user of remote control device 100. Information providing server 2030 is a computer system operated, for example, by manufacturers of air conditioner 1720, television 1730, HDD recorder 1740, VTR 1750 and the like. Information providing server 2030 therefore may exist corresponding to each control target equipment and therefore not always be realized by only one server as shown in FIG. 23.

It is noted that information providing server 2030 is realized, for example, by a general computer system. The hardware configuration and the realized function of the computer system are well known. Therefore, the detailed description will not be repeated here except for the following explanation.

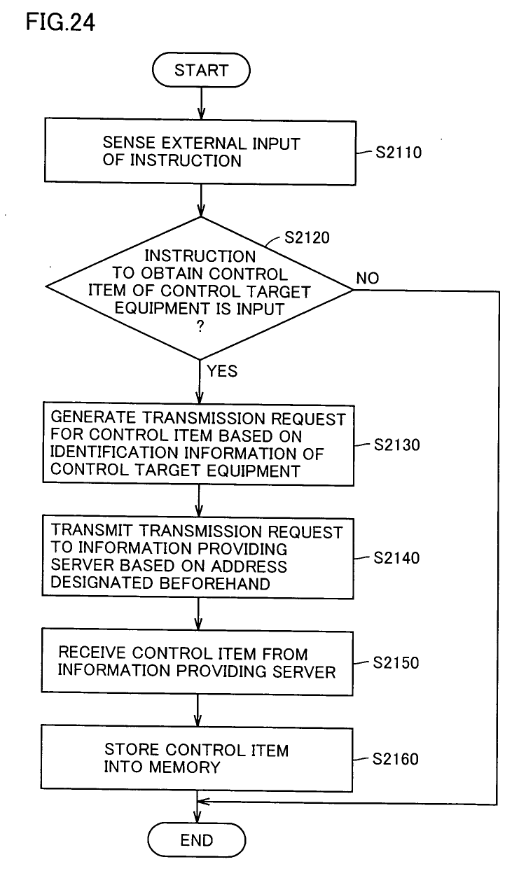

Referring to FIG. 24, the control structure of remote control device 100 in accordance with the present embodiment will be described. FIG. 24 is a flowchart illustrating a procedure of a process performed by control circuit 210 to receive a control item of control target equipment.

At step S1210, control circuit 210 senses an external input of an instruction based on an input through operation portion 140. At step S2120, control circuit 210 determines whether or not an instruction to obtain a control item of control target equipment is input based on the input. If the instruction is input (YES at step S2120), the process moves on to step S2130. If not (NO at step S2120), the process ends.

At step S2130, control circuit 210 generates a transmission request for a control item of control target equipment based on the identification information of the control target equipment stored in memory 220. This transmission request includes, for example, the identification information, information for identifying remote control device 100, and a communication protocol predetermined with the information providing server described later. In other words, this protocol is a predetermined command for requesting transmission of a control item.

At step S2140, control circuit 210 transmits the transmission request to information providing server 2030 based on an address designated beforehand. Upon reception of this request, information providing server 2030 generates data for transmitting the requested item and transmits the generated data to remote control device 100 that is the originator of the request. This data is received by PC 2010 and transmitted again to network 1790. Access point 1800 receives data from PC 2010. Sending portion 1720 sends the data, for example, as an infrared signal.

At step S2150, control circuit 210 receives the control item transmitted from information providing server 2030 through access point 1800. At step S2160, control circuit 210 stores the received control item in a predetermined data region in memory 220. In this way, remote control device 100 obtains a control item for controlling an operation that can be performed by particular control target equipment. Remote control device 100 can thereafter generate a signal for controlling the control target equipment based on an external instruction.

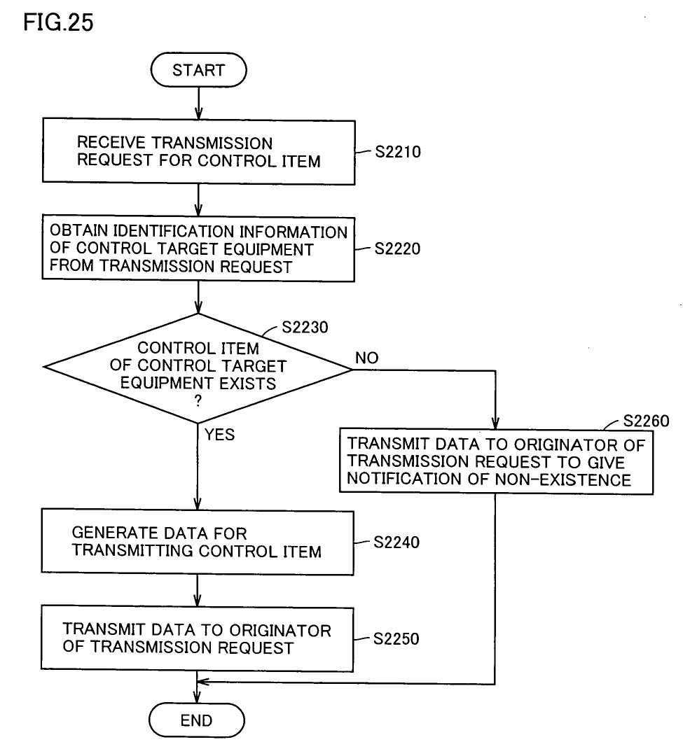

Here, referring to FIG. 25, control structure of information providing server 2030 in accordance with the present embodiment will be described. FIG. 25 is a flowchart illustrating a procedure of a process performed by information providing server 2030.

It is noted that information providing server 2030 is realized by a generally-known computer system as described above. The computer system generally includes a memory for storing data and a CPU for performing a predetermined process based on the data. Therefore, in the following description, the operation of information providing server 2030 is realized by CPU.

At step S2210, CPU receives a transmission request for a control item of control target equipment via network 1790 and the Internet 2020. At step S2220, CPU obtains identification information of control target equipment from the transmission request. The obtained identification information here includes, for example, the manufacturer code, equipment number, production number, and the like of control target equipment (FIG. 10).

At step S2230, CPU determines whether or not the control item of control target equipment exists in the memory. If the control item exists in the memory (YES at step S2230), the process moves on to step S2240. If not (NO at step S2230), the process moves on to step S2260.

At step S2240, CPU generates data for transmitting the control item. This data includes a data header and a data body including the control item. At step S2250, CPU transmits the data to an originator of the transmission request (that is, remote control device 100). Suppose that network 1790 is always connected to the Internet through PC 2010, remote control device 100 can receive the data quickly.

At step S2260, CPU generates data to give notification that the control item of control target equipment does not exist and transmits the generated data to the originator of the transmission request (remote control device 100). Upon reception of such data, remote control device 100 displays a message based on the received data on display 102.

As described above, in accordance with the fourth embodiment of the present invention, when information for controlling control target equipment is provided by an external information providing company (for example, a manufacturer of control target equipment), remote control device 100 can obtain the information via the Internet 2020. In this way, the latest information of control target equipment can always be obtained, thereby realizing accurate control, for example, even if control target equipment is upgradable equipment.

Specifically, when a function can be expanded or added by updating the firmware of control target equipment, the remote control device can obtain data for controlling the control target equipment after the expansion or after the addition. As a result, in addition to the improved convenience as described above, it is possible to easily adapt to so-called model change involving addition of a function of control target equipment. Accordingly, the terminal is less likely to be discarded due to the lack of the control functions in the terminal.

### Fifth Embodiment

In the following, a fifth embodiment of the present invention will be described. Remote control device 100 in accordance with the present embodiment differs from each embodiment described above in that it receives a signal from an original remote control device unique to control target equipment to function as a remote control device for the control target equipment based on the signal.

It is noted that the hardware configuration of the remote control device in accordance with the present embodiment is the same as the hardware configuration of the remote control device in accordance with each embodiment described above. The functions are also the same. Therefore, description thereof will not be repeated here.

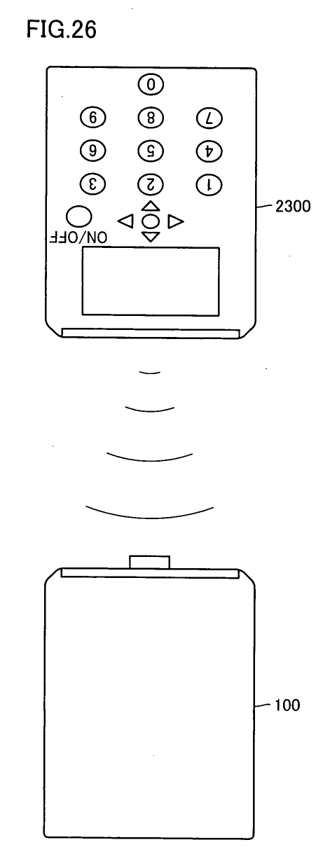

Referring to FIG. 26, a usage manner of remote control device 100 in accordance with the present embodiment will be described. FIG. 26 illustrates a state of communication of a signal between remote control device 100 and a remote control device 2300 unique to control target equipment.

Remote control device 2300 transmits a predetermined control signal corresponding to particular equipment. For example, when the user of remote control device 2300 presses a button “1”, a control signal including information corresponding to the pressed button is sent from a particular part (that is, a light-emitting portion). Then, camera 110 of remote control device 100 in accordance with the present embodiment is arranged with respect to remote control device 2300 at a position where the image of the light-emitting portion can be picked up, so that remote control device 100 can obtain information sent by remote control device 2300.

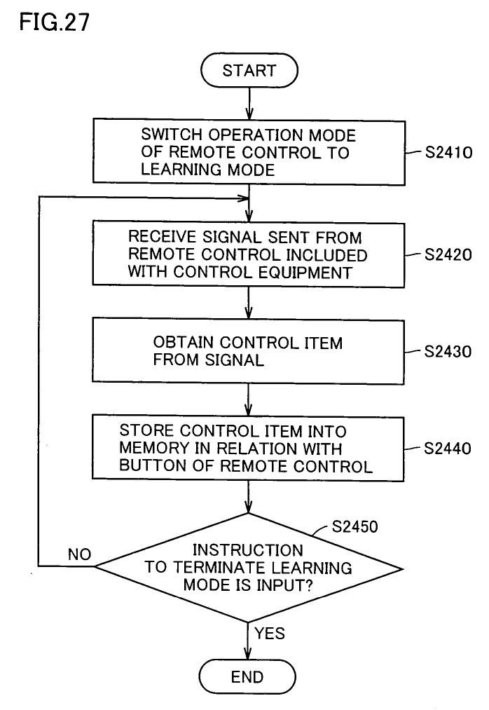

Referring to FIG. 27, the control structure of remote control device 100 in accordance with the present embodiment will be described. FIG. 27 is a flowchart illustrating a procedure of a process performed by remote control device 100 to perform a learning operation for remote control device 2300.

At step S2410, control circuit 210 of remote control device 100 switches its operation mode to a learning mode. Here, the learning mode refers to a process for storing information included in a received signal in a predetermined data region in memory 220.

At step S2420, control circuit 210 receives a signal sent from remote control device 2300 included with the control target equipment. At step S2430, control circuit 210 obtains a control item from the received signal. The control item obtained here is one item corresponding to a press on a particular button of remote control device 2300.

At step S2440, control circuit 210 relates the obtained control item with the operation portion (for example, a numeric button) held by remote control device 100 itself for storage in a region of memory 220. The manner of storage is, for example, as shown in regions 1040 and 1050 in FIG. 13.

At step S2450, control circuit 210 determines whether or not an instruction to terminate the learning mode is input. This determination is made based on whether or not an instruction input through operation portion 140 is to terminate the learning mode. If the termination instruction is input (YES at step S2450), the process ends. If not (NO at step S2450), the process returns to step S2440, and the process continues to obtain a control item of another remote control device 2300.

As described above, in remote control device 100 in accordance with the fifth embodiment of the present invention, a signal is received from a remote control device that control target equipment originally has, thereby obtaining information for controlling the control target equipment. In this way, remote control device 100 no longer obtains erroneous information and therefore can operate accurately as a remote control device for particular control target equipment.

### Sixth Embodiment

In the following, a sixth embodiment of the present invention will be described. The remote control device in accordance with the present embodiment differs from each embodiment described above in that it has a function of storing newly obtained identification information when identification information different from the identification information stored in memory 220 is obtained. In other words, remote control device 100 can sense a change of equipment for which it functions based on a difference in identification information.

It is noted that the hardware configuration of the remote control device in accordance with the present embodiment is the same as the hardware configuration of the remote control device in accordance with each embodiment described above. The functions are also the same. Therefore, description thereof will not be repeated here.

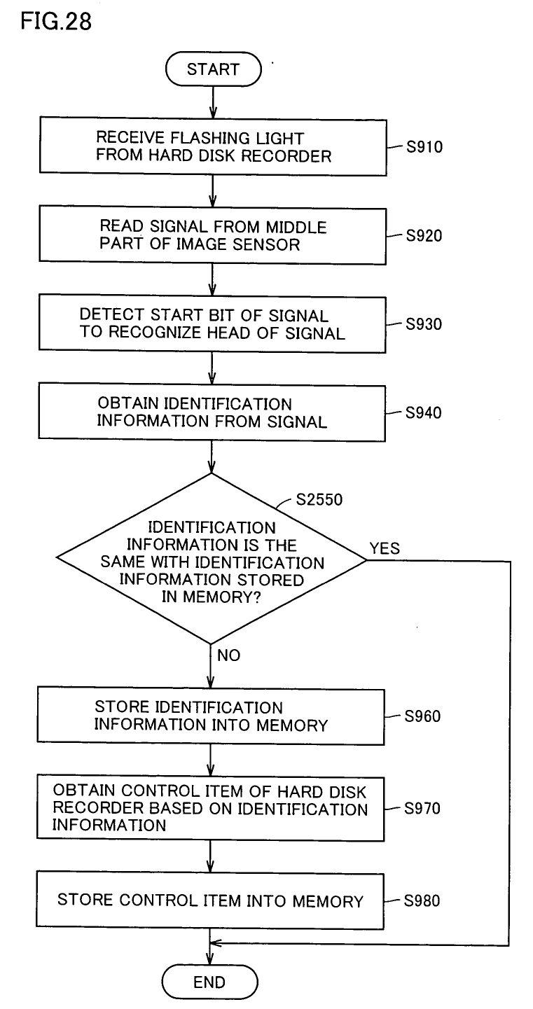

Referring to FIG. 28, the control structure of remote control device 100 in accordance with the present embodiment will be described. FIG. 28 is a flowchart illustrating a procedure of a process performed by control circuit 210 to update control items of control target equipment. It is noted that the same process as the process in each embodiment described above is denoted with the same step number. Therefore, description thereof will not be repeated here.

At step S2550, control circuit 210 determines whether or not the obtained identification information is the same as the identification information stored in memory 220. If these identification information are same (YES at step S2550), the process ends. If not (NO at step S2550), the process moves on to step S960, and the identification information and control item are obtained (steps S960-S980).

As described above, the remote control device in accordance with the sixth embodiment of the present invention obtains data for controlling newly recognized equipment when it recognizes equipment different from the already recognized equipment as a result of authentication processing. If the same equipment as the already recognized equipment is recognized again, the data is not obtained. Accordingly, while quickly switching to a remote control device corresponding to the control target equipment, the remote control device functions, as it is, as a remote control device corresponding to the same equipment. Therefore, whether the user of remote control device 100 is different or the same, it can operate as a terminal for particular control target equipment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A remote control device controlling control target equipment sending flashing light, said flashing light including identification information for identifying said control target equipment, said identification information being specified by a flashing condition of said flashing light, comprising:
an input portion externally receiving an input of an instruction;
an image pickup portion picking up an image of a subject based on said instruction;
a reception portion receiving the flashing light sent by said control target equipment, wherein directivity of said reception portion is the same direction as an optical axis of said image pickup portion;
a detection portion detecting the flashing condition of the flashing light received by said reception portion;
an obtaining portion obtaining said identification information based on said flashing condition;
an identification information storing portion storing the identification information obtained by said obtaining portion;
a generation portion responsive to an input of an instruction through said input portion to generate a control signal for controlling an operation of said control target equipment based on the identification information stored in said identification information storing portion; and
an output portion outputting said control signal.

2. The remote control device according to claim 1, further comprising a casing, wherein said image pickup portion and said reception portion are arranged on a predetermined face of said casing.

3. The remote control device according to claim 2, wherein said reception portion is arranged on the optical axis of said image pickup portion.

4. The remote control device according to claim 2, wherein said output portion includes
a conversion portion converting said control signal to infrared light, and
a light-emitting portion applying said infrared light.

5. The remote control device according to claim 2, wherein said output portion includes
a conversion portion converting said control signal to control data according to a communication line connected to said control target equipment, and
a transmission portion transmitting said control data to said control target equipment via said communication line.

6. The remote control device according to claim 2, further comprising:
an item obtaining portion obtaining a control item defining an operation by said control target equipment based on said identification information; and
a storage portion storing the control item obtained by said item obtaining portion in relation with said identification information, wherein
said generation portion generates said control signal based on the control item stored in said storage portion and said identification information.

7. The remote control device according to claim 6, wherein said item obtaining portion includes
a transmission request portion asking said control target equipment for transmission of said control item via a communication line connected to said control target equipment, and
an item receiving portion receiving said control item transmitted by said control target equipment via said communication line.

8. The remote control device according to claim 6, wherein said item obtaining portion includes
a feeding portion connected to a communication line to feed a transmission request for said control item to an information providing device providing said control item via said communication line, and
an item receiving portion receiving said control item transmitted according to said transmission request via said communication line.

9. The remote control device according to claim 6, wherein said item obtaining portion includes a reception portion receiving a control signal sent by a remote control terminal unique to said control target equipment.

10. The remote control device according to claim 2, further comprising:
a storage portion storing a control item obtained beforehand for said control target equipment and identification information of said control target equipment; and
a determination portion determining whether or not the identification information obtained by said obtaining portion agrees with the identification information stored in said storage portion, wherein
said generation portion generates said control signal based on said control item obtained beforehand, if the identification information obtained by said obtaining portion agrees with the identification information stored in said storage portion.

11. The remote control device according to claim 2, further comprising:
an image data storing portion storing data generated by picking up an image of said subject;
a display portion displaying an image; and
a display control portion displaying the image of the subject picked up by said image pickup portion on said display portion based on the data stored in said image data storing portion, until said obtaining portion obtains said identification information.

12. A remote control device controlling control target equipment sending flashing light, said flashing light including identification information for identifying said control target equipment, said identification information being specified by a flashing condition of said flashing light, comprising:
a casing;
an input portion externally receiving an input of an instruction;
an image pickup portion arranged on a predetermined face of said casing to pick up an image of a subject based on said instruction;
an image data storing portion storing data generated by picking up an image of said subject;
a display portion displaying an image;
a reception portion arranged on a predetermined face of said casing to receive the flashing light sent by said control target equipment, wherein directivity of said reception portion is the same direction as an optical axis of said image pickup portion;
a detection portion detecting the flashing condition of the flashing light received by said reception portion;
an obtaining portion obtaining said identification information based on said flashing condition;
a display control portion displaying on said display portion an image of the subject picked up by said image pickup portion based on the data stored in said image data storing portion, until said obtaining portion obtains said identification information;
an identification information storing portion storing the identification information obtained by said obtaining portion;
a generation portion responsive to an input of an instruction through said input portion to generate a control signal for controlling an operation of said control target equipment based on said identification information;
a conversion portion converting said control signal to infrared light; and
a light-emitting portion applying said infrared light.
